(19) United States
(12) Patent Application Publication
(10) Pub. No.: US 2008/0277512 A1
(43) Pub. Date: Nov. 13, 2008

(54) INGREDIENT DISPENSING APPARATUS

(75) Inventor: Remco Douwinus VUIJK, Malmsbury (GB)

Correspondence Address: MORRISON & FOERSTER LLP, 1650 TYSONS BOULEVARD, SUITE 400, MCLEAN, VA, 22102, US

(73) Assignee: DYSON TECHNOLOGY LIMITED, Malmesbury (GB)

(21) Appl. No.: 12/052,622

(22) Filed: Mar. 20, 2008

(30) Foreign Application Priority Data
Mar. 21, 2007 (GB) 0705363.0

(51) Int. Cl. B02B 5/02; B67D 5/52; B67D 5/06; G01F 11/20

(52) U.S. Cl. 241/101.8; 222/144.5; 222/139; 222/141; 222/236; 222/413

(57) ABSTRACT

The invention provides an ingredient dispensing apparatus (100; 200) comprising first and second hoppers (102, 104; 202, 204) for storage of an ingredient, first and second dispensers (120, 124; 214, 224) for dispensing an ingredient from the respective hopper (102, 104; 202, 204) and a drive mechanism (128; 228) for rotatably driving the first and second dispensers (120, 124; 214, 224). The first and second dispensers (120, 124; 214, 224) are arranged such that, in a first direction (D1) of rotation of the drive mechanism (128; 228), the first dispenser (120; 214) dispenses an ingredient from the first hopper (102; 202) and in a second direction (D2) of rotation of the drive mechanism (128; 228), the second dispenser (124; 224) dispenses an ingredient from the second hopper (104; 204). Further, the invention also provides an ingredient dispensing apparatus (100; 200) comprising first and second hoppers (102, 104; 202, 204) for storage of an ingredient, first and second dispensers (120, 124; 214, 224) for dispensing an ingredient from the respective hopper (102, 104; 202, 204) and a drive mechanism (128; 228) for rotatably driving the first and second dispensers (120, 124; 214, 224). The first and second dispensers (120, 124; 214, 224) are driven by a common drive mechanism (128; 228). The above arrangements allow the ingredient dispensing apparatus (100; 200) to be more compact.

The present invention relates to an ingredient dispensing apparatus. More particularly, the present invention relates to an ingredient dispensing apparatus comprising first and second hoppers for dispensing an ingredient.

Ingredient dispensers are well known in the art. A popular example can be found in a coffee machine. Many coffee machines comprise, or can be accompanied by, a grinder for grinding coffee beans and dispensing ground coffee for use in brewing a beverage. For example, U.S. Pat. No. 5,172,868 discloses a home coffee grinder. The apparatus disclosed therein comprises a motor which drives a drive shaft. On the drive shaft is located an auger and a grinder, the auger feeding the grinder with coffee beans for grinding. The ground coffee falls into a suitable receptacle for collection.

Another example of a coffee dispenser including a grinder is shown in U.S. Pat. No. 4,936,515. This document discloses a hopper for ground coffee which has an auger at a lower end. A grinder is located coaxially with the auger. The grinder and the auger are powered by a separate drive mechanism. In use, the auger feeds coffee beans into the grinder for grinding and subsequent dispensing.

It is also known to provide ingredient dispensers for dispensing a plurality of ingredients. These arrangements find particular application in commercial vending or beverage preparation machines where different users may require different types of product; for example decaffeinated coffee or hot chocolate. An example of this type of ingredient dispenser is shown in U.S. Pat. No. 4,974,751. This document discloses a dual hopper arrangement in which spiral augers are used to dispense one of two ingredients. Each of the augers is driven by a separate motor.

It is also known to provide hoppers for storing two different types of coffee bean for grinding. U.S. Pat. No. 4,971,259 discloses a dual hopper coffee grinder. In the disclosed arrangement, two separate hoppers are provided which feed into a common grinder. The outlets from the hoppers are selectively opened by means of separate reciprocal slides operated by separate solenoids.

The above arrangements for dispensing more than one type of ingredient suffer from the drawback that multiple drive mechanisms (such as a plurality of motors) are required. This adds to the size, complexity and cost of the dispensers.

It is, therefore, an object of the present invention to provide an ingredient dispensing apparatus which is able to dispense more than one type of ingredient, but which does not require a plurality of drive mechanisms. It is a further object of the present invention to provide an ingredient dispensing apparatus which is capable of selectively dispensing an ingredient from one of two hoppers using a common control mechanism.

By the term ingredient we mean a foodstuff product. In particular, we mean a foodstuff product which can be dispensed for use in a direct form (for example; ground nuts or spices) or which can be used to produce another product such as a beverage product (for example; coffee beans for making a coffee drink, soup powder for making an instant soup drink, fruit puree which is added to water to make a fruit drink).

According to the invention, there is provided an ingredient dispensing apparatus comprising first and second hoppers for storage of an ingredient, first and second dispensers for dispensing an ingredient from the respective hopper and a drive mechanism for rotatably driving the first and second dispensers, wherein the first and second dispensers are arranged such that, in a first direction of rotation of the drive mechanism, the first dispenser dispenses an ingredient from the first hopper and in a second direction of rotation of the drive mechanism, the second dispenser dispenses an ingredient from the second hopper.

By providing such an arrangement, the need for complex control mechanisms or multiple drive mechanisms is avoided. This reduces the size and cost of the ingredient dispensing apparatus.

According to the invention, there is also provided an ingredient dispensing apparatus comprising first and second hoppers for storage of an ingredient, first and second dispensers for dispensing an ingredient from the respective hoppers and a drive mechanism for rotatably driving the first and second dispensers, wherein the first and second dispensers are driven by a common drive mechanism.

By providing such an arrangement, the need for more than one drive mechanism, such as a motor, is eliminated. This allows the ingredient dispensing apparatus to be more compact, less expensive and less prone to wear.

Preferably, the first and second dispensers are arranged coaxially on a common drive shaft. This arrangement allows the drive mechanism to drive the dispensers together without additional linkages or drive shafts. This reduces the size and complexity of the apparatus.

Preferably, the drive mechanism comprises an electric motor having an axis of rotation which is arranged at an angle to the common drive shaft. More preferably, the axis of rotation of the electric motor is substantially perpendicular to the common drive shaft. By providing such an arrangement, the ingredient dispensing apparatus can be more compact, allowing the ingredient dispensing apparatus to be inserted into a compact domestic appliance.

Preferably, at least one of the first and second hoppers includes a stirrer which is driven by the common drive mechanism. Preferably, the stirrer is rotatable about an axis which is perpendicular to a base of the hopper. More preferably, the stirrer includes a spiral stirrer adjacent a base of the first or second hopper.

By providing a spiral stirrer, the ingredient contained within the hopper can be smoothly guided to the dispenser. The stirrer prevents a build up of ingredient in, for example, a corner of one of the hoppers.

According to the invention, there is also provided an ingredient dispensing apparatus comprising first and second hoppers for storage of ingredients, the first hopper having a grinder and the second hopper having a dispenser, wherein the grinder and the dispenser are driven by a common drive mechanism.

Preferably, the grinder and the dispenser are arranged coaxially on a common drive shaft. This arrangement allows the drive mechanism to drive the grinder and the dispenser together without additional linkages or drive shafts. This reduces the size and complexity of the apparatus.

Preferably, the drive mechanism comprises an electric motor having an axis of rotation which is arranged at an angle to the common drive shaft. More preferably, the axis of rotation of the electric motor is substantially perpendicular to the common drive shaft. By providing such an arrangement, the ingredient dispensing apparatus can be more compact, allowing the ingredient dispensing apparatus to be inserted into a compact domestic appliance.

Preferably, the drive mechanism is rotatable in first and second directions and the grinder and dispenser are adapted and arranged such that, in the first direction of rotation of the drive mechanism, the grinder grinds an ingredient from the first hopper and, in the second direction of rotation of the drive mechanism, the dispenser dispenses an ingredient from the second hopper.

Preferably, the first hopper further includes a dispenser. More preferably, the dispenser is an auger. By providing a dispenser in the first hopper in addition to the grinder, the grinder is fed with an ingredient to be ground, resulting in more consistent grinding.

Preferably, at least one of the first and second hoppers include a stirrer which is driven by the common drive mechanism. More preferably, the stirrer includes a spiral stirrer adjacent a base of the first or second hopper.

There is also provided a beverage dispensing machine arranged to dispense a liquid beverage and including an ingredient dispensing apparatus according to the invention. Preferably, the beverage dispensing machine is a coffee machine.

According to the invention, there is also provided an ingredient dispensing apparatus comprising at least one hopper for holding an ingredient, the at least one hopper including an outlet, a base and an auger disposed adjacent the base and arranged to guide the ingredient from the hopper to the outlet, the hopper further including a stirrer for stirring the ingredient, wherein the stirrer is driven by the auger, is rotatable relative to the base of the hopper and is arranged to direct the ingredient towards the auger.

By providing such an arrangement, a build up of ingredient in, for example, the corner of a hopper is prevented and substantially all of the ingredient in the hopper can be conveyed to the auger, and subsequently the outlet, for dispensing.

Preferably, the stirrer is rotatable about an axis which is perpendicular to the base of the hopper. More preferably, the stirrer is a spiral stirrer. By providing such an arrangement, the hopper can be compact and the ingredient can be conveyed efficiently to the auger and subsequently the outlet for dispensing.

Embodiments of the invention will now be described with reference to the accompanying drawings, in which:

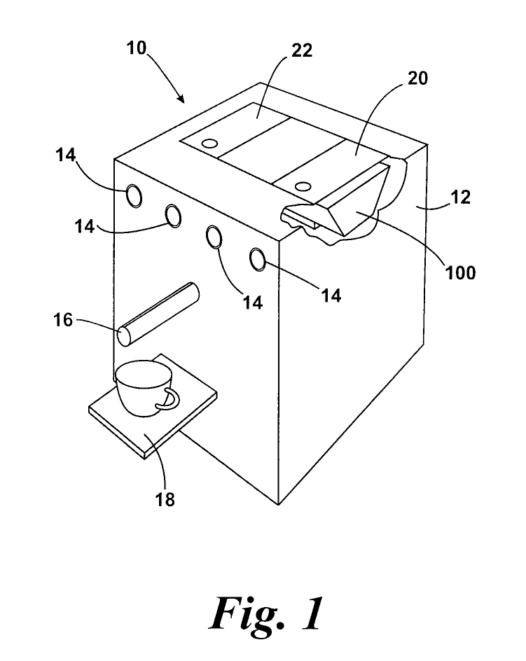

FIG. 1 is a partially cut away perspective view of a coffee machine including the ingredient dispensing apparatus according to the present invention;

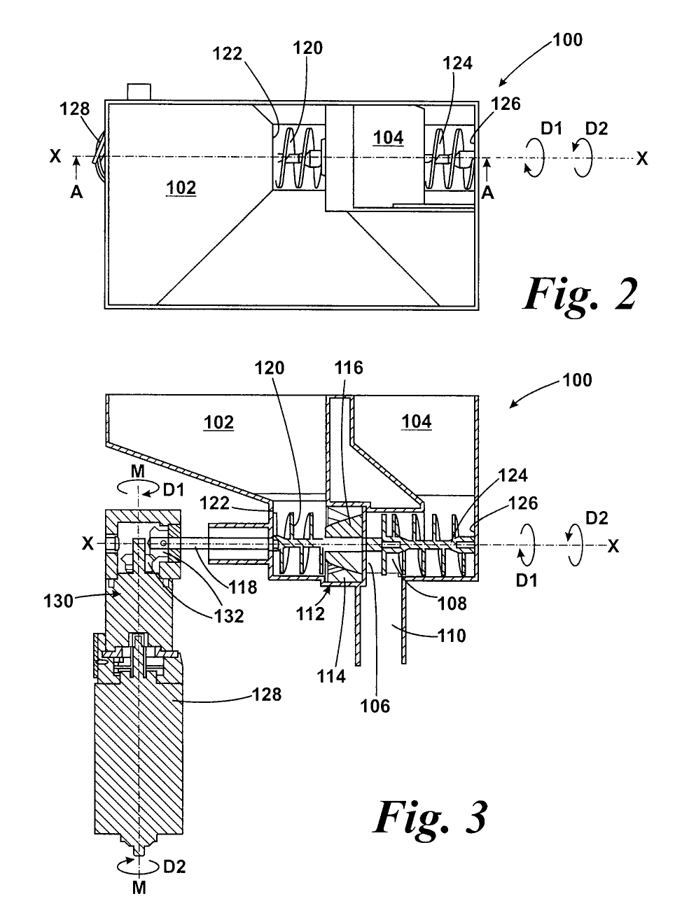

FIG. 2 is a plan view of an ingredient dispensing apparatus, suitable for use in the coffee machine of FIG. 1, according to a first embodiment of the invention;

FIG. 3 is a side section taken along the line A-A of FIG. 2 showing the ingredient dispensing apparatus of FIG. 2;

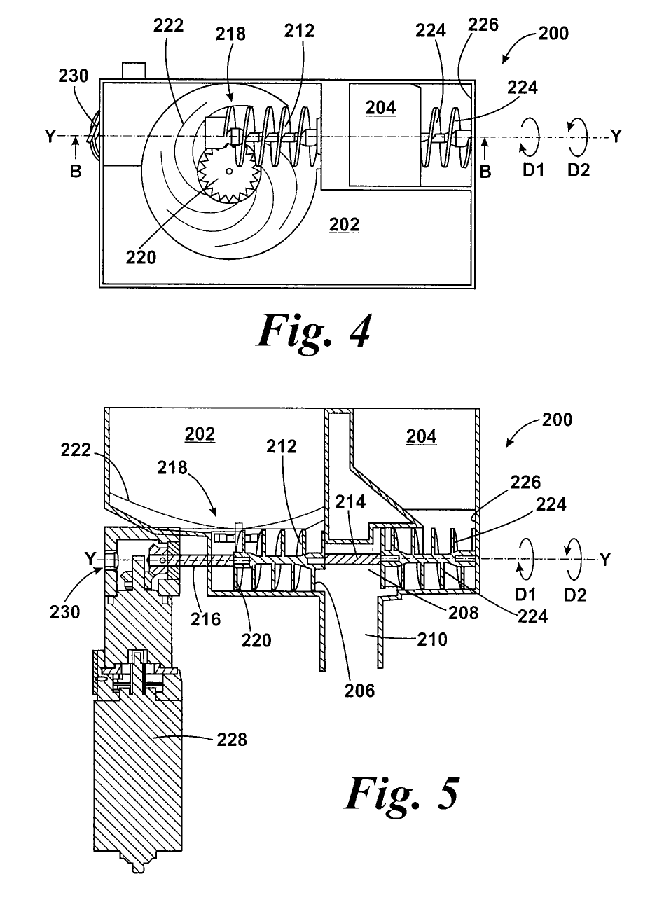

FIG. 4 is a plan view of an ingredient dispensing apparatus, suitable for use in the coffee machine of FIG. 1, according to a second embodiment of the invention; and

FIG. 5 is a side section taken along the line B-B of FIG. 4 showing the ingredient dispensing apparatus of FIG. 4.

FIG. 1 shows an example of a coffee machine 10. The coffee machine 10 has a main body 12. The main body 12 includes a plurality of selection buttons 14, a dispensing spout 16 and a support tray 18. The main body 12 further includes a pair of access doors 20, 22 located on an upper surface. The access doors 20, 22 are slidably arranged to allow an ingredient to be inserted into a part of an ingredient dispensing apparatus 100 according to the invention. The access doors 20, 22 are arranged so that only one of the doors 20, 22 may be open at any one time. When a user closes one of one of the doors 20, 22, the other of the doors 22, 20 is arranged to open.

In use, a user loads an ingredient into the ingredient dispensing apparatus 100 by sliding the access doors 20, 22 to a desired position. The user then places a cup or mug on the support tray 18 underneath the dispensing spout 16 and selects a desired beverage by pressing one of the plurality of selection buttons 14. An ingredient is taken from the ingredient dispensing apparatus 100 and a beverage is brewed. The brewed beverage is then dispensed from the dispensing spout 16 into the cup or mug provided.

FIGS. 2 and 3 show the ingredient dispensing apparatus 100 in more detail. The ingredient dispensing apparatus 100 comprises first and second hoppers 102, 104. The first and second hoppers 102, 104 have upper ends which are covered by access doors 20, 22 respectively when the ingredient dispensing apparatus 100 is located in the coffee machine 10. The first and second hoppers 102, 104 also include first and second outlets 106, 108 which are each in communication with a common dispensing outlet 110.

A grinder 112 is located in the first hopper 102 adjacent the first outlet 106. The grinder 112 comprises first and second grinding elements 114, 116. The first grinding element 114 is fixed relative to the first hopper 102 and the second grinding element 116 is rotatable within the first grinding element 114 to allow an ingredient (not shown) to be ground. The second grinding element 116 is located on a shaft 118 having an axis of rotation X-X. The first and second grinding elements 114, 116 each comprise burrs which are rotatable with respect to one another to effect a grinding action when the second grinding element 116 is driven in a first direction D1. When driven in a second direction D2, the grinder 112 does not grind.

A first auger 120 is located in the first hopper 102 and is arranged to feed an ingredient to be ground from the first hopper 102 to the grinder 112. The first auger 120 is also located on the shaft 118 and is rotatable about the axis X-X. When driven in the first direction D1, the first auger 120 is arranged to feed the ingredient towards the grinder 112. When driven in the second direction D2, the first auger 120 is arranged to move the ingredient away from the grinder 112 and towards a wall 122 of the first hopper 102. When driven in the second direction D2, ground ingredient is not dispensed from the first hopper 102.

A second auger 124 is located in the second hopper 104 adjacent the second outlet 108. The second auger 124 is arranged on the shaft 118 and is rotatable about the axis of rotation X-X of the shaft 118. The second auger 124 is arranged to dispense a ground ingredient from the second hopper 104 when rotated in the second direction D2. In the second direction of rotation D2, the ground ingredient is conveyed from within the second hopper 104, along the second auger 124, into the second outlet 108 and down the common outlet 110.

However, the second auger 124 is arranged so that a ground ingredient is not dispensed from the second hopper 104 when the second auger 124 is rotated in the first direction D1. When rotated in the first direction D1, the second auger 124 moves the ground ingredient towards a wall 126 of the second hopper 104 and the ground ingredient remains in the second hopper 104.

The ingredient dispensing apparatus 100 further includes a motor 128 and a gear assembly 130. The motor 128 is arranged to rotate in first and second directions of rotation D1, D2. The gear arrangement 130 comprises a pair of bevel gears 132. One of the bevel gears 132 is connected to the motor 128 and the other of the bevel gears 132 is connected to the shaft 118. The bevel gears 132 are arranged to translate the rotational motion of the motor 128 through 90° so that the shaft 118 is driven in a direction perpendicular to the axis of rotation M-M of the motor 128. The first and second directions of rotation D1, D2 of the shaft 118 correspond directly to the first and second directions of rotation D1, D2 of the motor 128.

The motor 128 and gear assembly 130 drive the shaft 118 in either the first or the second directions D1, D2. When the shaft 118 is driven, the grinder 112, first auger 120 and second auger 124 are all rotated in the same direction. Therefore, only a single motor 128 is required to drive the dispensing arrangements for both of the first and second hoppers 102, 104. This reduces the cost, complexity and size of the ingredient dispensing apparatus 100.

In use, a user places an ingredient to be ground (for example, coffee beans) into the first hopper 102 and a ground ingredient (for example, ground coffee) into the second hopper 104. The user then selects an mode of operation using the selection buttons 14 (see FIG. 1). If a user selects (for example) freshly ground coffee, then the motor 128 rotates in the first direction D1 and, through the bevel gears 132, drives the shaft 118 in the first direction D1. Coffee beans in the first hopper 102 are then moved towards the grinder 112 by the first auger 120. The coffee beans are ground to a desired consistency between the burrs of the first and second grinding elements 114, 116 of the grinder 112.

The freshly-ground coffee then passes through the grinder 112, out of the first outlet 106 and is dispensed from the common outlet 110. The common outlet 110 leads to additional parts of the coffee machine 10, such as a brewing head (not shown) for preparation of a coffee drink.

During this operation, the second auger 124 will also rotate in the first direction D1. However, because the helical screw of the second auger 124 is arranged in an opposing direction to that of the first auger 120, the second auger 124 will push the ground coffee in the second hopper 104 towards the wall 126 of the second hopper 104. Therefore, no pre-ground coffee will be dispensed from the second hopper 104.

Alternatively, the user may select, for example, pre-ground coffee. In this case, the motor 128 is rotated in the second direction D2. This action rotates the shaft 118 in the second direction D2 and, thus, drives the grinder 112, first auger 120 and second auger 124 in the second direction D2.

The helical screw of the second auger 124 is arranged to dispense pre-ground coffee from the second hopper 104 when driven in the second direction D2. Therefore, when in this mode of operation, the pre-ground coffee stored in the second hopper 104 is transported from the second hopper, along the second auger 124, through the second outlet 108 and is dispensed from the common outlet 110. The common outlet 110, as previously described, leads to additional parts of the coffee machine 10, such as a brewing head (not shown).

However, when driven in the second direction D2, the first auger 120 does not feed coffee beans to the grinder 112. Instead, the coffee beans are transported in the opposite direction and are pushed against the wall 122 of the first hopper 102. Hence, the coffee beans remain in the first hopper 102 and are not dispensed. Additionally, the burrs on the first and second elements 114, 116 of the grinder 112 are arranged so that no grinding takes place when the second element 116 is rotated in the second direction D2.

FIGS. 4 and 5 show an ingredient dispensing apparatus 200 according to a second embodiment of the invention. The ingredient dispensing apparatus 200 is suitable for use in the coffee machine 10 of FIG. 1. The second embodiment of the invention differs from the first embodiment in that the second embodiment is arranged to dispense two different types of pre-ground ingredient or ingredient that does not require grinding. The ingredient dispensing apparatus 200 comprises first and second hoppers 202, 204 which are similar to the first and second hoppers 102, 104 of the first embodiment. The first and second hoppers 202, 204 include first and second outlets 206, 208 which are in communication with a common dispensing outlet 210.

A first auger 212 is located in the first hopper 202 adjacent the first outlet 206. The first auger 212 is located on a shaft 214 having an axis of rotation Y-Y. When driven in a first direction D1, the first auger 212 is arranged to feed a ground ingredient towards the first outlet 206 and into the common dispensing outlet 210. When driven in a second direction D2, the first auger 212 is arranged to move the ingredient away from the first outlet 206 and towards a wall 216 of the first hopper 202. When driven in the second direction D2, the ground ingredient is not dispensed from the first hopper 202.

The first hopper 202 further comprises a stirring mechanism 218. The stirring mechanism 218 includes a drive gear 220 which meshes with the first auger 212 in order to be driven thereby. A spiral stirrer 222 is connected to the drive gear 220 and moves therewith. The stirrer 222 is located adjacent the base of the first hopper 202 and acts as an anti-bridging means. The stirrer 222 guides the ground ingredient towards the first auger 212, preventing build-up of ground ingredient in, for example, the comers of the first hopper 202. The stirrer 222 will operate in either direction, depending upon the direction of rotation of the first auger 212.

A second auger 224 is located in the second hopper 204 adjacent the second outlet 208. The second auger 224 is arranged on the shaft 214 and is rotatable about the axis of rotation Y-Y of the shaft 214. The second auger 224 is arranged to dispense a ground ingredient from the second hopper 204 when rotated in the second direction D2. This is achieved by orientating the helical screw of the second auger 224 in the opposite direction to the first auger 212. In the second direction of rotation D2, the second auger 224 is arranged to convey the ground ingredient from within the second hopper 204, along the second auger 224, into the second outlet 208 and into the common outlet 210.

The second auger 224 is arranged so that a ground ingredient is not dispensed from the second hopper 204 when the second auger 224 is rotated in the first direction D1. When rotated in the first direction D1, the second auger 224 moves the ground ingredient towards a wall 226 of the second hopper 204 and the ground ingredient remains in the second hopper 204.

The ingredient dispensing apparatus 200 further includes a motor 228 and a gear assembly 230. The motor 228 and gear assembly 230 are the same as the motor 128 and gear assembly 130 of the first embodiment and will not be discussed further.

In use, a user places two different ground ingredients (for example, caffeinated and decaffeinated coffee) into the first and second hoppers 202, 204. The user then selects a mode of operation using the selection buttons 14 (see FIG. 1). If a user selects caffeinated coffee from the first hopper 202, then the motor 228 rotates in the first direction D1 and drives the shaft 214 in the first direction D1. The first auger 212 conveys the caffeinated coffee from the first hopper 202 and out of the first outlet 206 to be dispensed from the common outlet 210. The common outlet 210 leads to additional parts of the coffee machine 10, such as a brewing head (not shown). During this process, the stirrer 222 rotates and stirs the caffeinated coffee within the first hopper 202. This action breaks up the coffee grounds and draws the coffee grounds towards the first auger 212 and first outlet 206.

During this operation, the second auger 224 will also rotate in the first direction D1. However, because the helical screw of the second auger 224 is arranged in an opposing direction to that of the first auger 214, the second auger 224 will push the ground coffee in the second hopper 204 towards the wall 226 of the second hopper 204. Therefore, no ground ingredient will be dispensed from the second hopper 204.

Alternatively, the user may select, for example, decaffeinated coffee stored in the second hopper 204. In this case, the motor 228 is rotated in the second direction D2 in order to rotate the shaft 214 in the second direction D2 and, thus, rotate the first and second augers 212, 224 in the second direction D2. In this case, the second auger 224 draws the decaffeinated coffee stored in the second hopper 204 towards the second outlet 208 from where it is dispensed into the common outlet 210. The decaffeinated coffee is then passed to another part of the coffee machine, for example a brewing head (not shown).

The invention is not limited to the detailed description given above. Variations will be apparent to the person skilled in the art. For example, the ingredient dispensing apparatus need not be located in a coffee machine. Any kind of dispensing apparatus would be suitable; for example, apparatus for dispensing hot chocolate, fruit juices, nuts or herbs and spices.

Further, additional types of ingredient could be used in addition to the foodstuff products discussed herein. For example; any suitable foodstuff products which can be dispensed to brew, flavour and mix with a drink or beverage may be used. Alternatively, ingredients to be used directly in food or drinks (for example; sugars, spices or nuts) may also be used.

The first and second hoppers are not limited to the arrangements shown in the Figures. The hoppers may be of equal size, or the second hopper may be larger than the first hopper. Further hoppers may also be provided.

Additionally, the first and second hoppers may be arranged to be removable. This may be advantageous to allow, for example, the hoppers to be cleaned or to be filled at a location remote from the beverage dispensing apparatus. Various configurations of removable hopper may be used. For example, each of the hoppers may be removable together with a part of the drive shaft or drive mechanism. A suitable connector (such as, for example, a drive dog) may be used to couple the removable parts of the drive mechanism to the parts which are not removable. Alternatively, the entire drive mechanism may remain in place and each hopper may be released and removed around the drive mechanism.

Further, dispensers other than augers could be used. For example, a moving conveyor, belt arrangement or rotatable paddles could be used instead of a helical member such as an auger. What is important is that, in a first direction of rotation of the motor and gear arrangement, an ingredient is dispensed from the first hopper and in a second direction of rotation of the motor and gear arrangement, an ingredient is dispensed from the second hopper.

Additionally, an auger need not be provided in the first hopper and, instead, only a grinder need be provided. An ingredient to be ground, for example, coffee beans, may be allowed to fall under gravity into the grinder, eliminating the need for an additional auger.

Additionally, the auger and the grinder, or the two augers, need not be disposed on the same shaft. What is important is that the dispensers for each hopper are driven by a common drive mechanism. This reduces the size, complexity and cost of the ingredient dispensing apparatus because only one motor or other driving device is required.

The rotational axis of the motor need not be located perpendicular to the axis of rotation of the augers and/or grinder. Other arrangements could be contemplated; for example, the rotational axis of the motor could be arranged parallel to the axis of rotation of the augers and/or grinder, or at an intermediate angle, for example, 45°.

A clutch may be provided between the motor and the dispenser, and/or between the motor and the grinder. If an object becomes stuck in the grinder or the dispenser, the clutch will slip, protecting the motor from damage or overloading.

Further, other arrangements for the stirrer may be used. For example, the stirrer need not require a gear and instead may be driven by a belt or other drive mechanism connected to the auger. Additionally, the stirrer need not be in the form of a spiral. Other arrangements could be used, for example; a plurality of paddles, a coil, fins, or baffles.

1. An ingredient dispensing apparatus comprising first and second hoppers for storage of an ingredient, first and second dispensers for dispensing an ingredient from the respective hopper and a drive mechanism for rotatably driving the first and second dispensers, wherein the first and second dispensers are arranged such that, in a first direction of rotation of the drive mechanism, the first dispenser dispenses an ingredient from the first hopper and in a second direction of rotation of the drive mechanism, the second dispenser dispenses an ingredient from the second hopper.

2. An ingredient dispensing apparatus as claimed in claim 1, wherein the first and second dispensers are arranged coaxially on a common drive shaft.

3. An ingredient dispensing apparatus as claimed in claim 2, wherein the drive mechanism comprises an electric motor having an axis of rotation which is arranged at an angle to the common drive shaft.

4. An ingredient dispensing apparatus as claimed in claim 1, wherein at least one of the first and second dispensers is an auger.

5. An ingredient dispensing apparatus as claimed in claim 1, wherein at least one of the first and second hoppers include a stirrer which is driven by the drive mechanism.

6. An ingredient dispensing apparatus as claimed in claim 5, wherein the stirrer is rotatable about an axis which is perpendicular to a base of the hopper.

7. An ingredient dispensing apparatus as claimed in claim 6, wherein the stirrer includes a spiral stirrer adjacent the base of the first or second hopper.

8. A beverage dispensing machine arranged to dispense a liquid beverage and including an ingredient dispensing apparatus as claimed in claim 1.

9. A beverage dispensing machine as claimed in claim 8, wherein the beverage dispensing machine is a coffee machine.

10. An ingredient dispensing apparatus comprising first and second hoppers for storage of ingredients, the first hopper having a grinder and the second hopper having a dispenser, wherein the grinder and the dispenser are driven by a common drive mechanism.

11. An ingredient dispensing apparatus as claimed in claim 10, wherein the grinder and the dispenser are arranged coaxially on a common drive shaft.

12. An ingredient dispensing apparatus as claimed in claim 11, wherein the drive mechanism comprises an electric motor having an axis of rotation which is arranged at an angle to the common drive shaft.

13. An ingredient dispensing apparatus as claimed in claim 12, wherein the axis of rotation of the electric motor is substantially perpendicular to the common drive shaft.

14. An ingredient dispensing apparatus as claimed in claim 10, wherein the drive mechanism is rotatable in first and second directions and the grinder and dispenser are adapted and arranged such that, in the first direction of rotation of the drive mechanism, the grinder grinds an ingredient from the first hopper and, in the second direction of rotation of the drive mechanism, the dispenser dispenses an ingredient from the second hopper.

15. An ingredient dispensing apparatus as claimed in claim 10, wherein the first hopper further includes a dispenser.

16. An ingredient dispensing apparatus as claimed in claim 10, wherein the dispenser is an auger.

17. An ingredient dispensing apparatus as claimed in claim 10, wherein at least one of the first and second hoppers include a stirrer which is driven by the common drive mechanism.

18. An ingredient dispensing apparatus as claimed in claim 17, wherein the stirrer include a spiral stirrer adjacent a base of the first or second hopper.

19. A beverage dispensing machine arranged to dispense a liquid beverage and including an ingredient dispensing apparatus as claimed in claim 10.

20. A beverage dispensing machine as claimed in claim 19, wherein the beverage dispensing machine is a coffee machine.
